(19) United States
(12) Patent Application Publication
(10) Pub. No.: US 2017/0202730 A1
(43) Pub. Date: Jul. 20, 2017

(54) FOAM ROLLER

(71) Applicant: MENG CHIEN LIN, TAICHUNG C ITY (TW)

(72) Inventor: MENG CHIEN LIN, TAICHUNG C ITY (TW)

(21) Appl. No.: 15/168,041

(22) Filed: May 28, 2016

(30) Foreign Application Priority Data
Jan. 14, 2016 (TW) 105200490

(51) Int. Cl. A61H 15/00; B29C 65/02

(52) U.S. Cl. CPC A61H 15/0092; B29C 65/02; B29L 2031/32

(57) ABSTRACT

A foam roller includes a body having a passage defined axially therethrough. A support coat is connected to the outer surface of the body and has a first layer and a second layer. The first layer has multiple slots through which multiple protrusions formed on the outside of the second layer extend. The protrusions extending through the slots form multiple massage portions. The second layer is connected to the outside of the first layer by way of heat pressing to form the support coat. The first and second layers have different colors. The color of the outside of each massage portion is different from the color of the first layer.

### BACKGROUND OF THE INVENTION

1. Fields of the Invention

The present invention relates to a foam roller, and more particularly, to a foam roller with two different colors.

2. Descriptions of Related Art

One of the conventional foam rollers known to applicant comprises a cylindrical body with a passage defined axially therethrough, and a foam coat is connected to the outside of the body. Multiple protrusions are formed on the outside of the foam coat by way of heat pressing. Each protrusion is printed to form a specific pattern, and a protection layer is coated to the patterns.

The patterns on the protrusions have different visual effect relative to the foam coat itself. However, some users do not like the patterns which make the foam roller a little bit “heavy” and complicated.

The present invention intends to provide a foam roller whose support coat includes a first layer and a second layer, and the second layer includes multiple protrusions which extend through slots defined through the first layer so as to provide different visual effect.

### SUMMARY OF THE INVENTION

The present invention relates to a foam roller and comprises a body which has a passage defined axially therethrough. The body has an inner surface and an outer surface. A support coat is connected to the outer surface of the body and has a first layer and a second layer. The first layer has multiple slots defined therethrough. The color of the second layer is different from the color of the first layer. Multiple protrusions are formed on the outside of the second layer. The second layer is connected to the outside of the first layer by way of heat pressing to form the support coat. The protrusions extend through the slots and form multiple massage portions. The color of the outside of each massage portion is different from the color of the first layer.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the foam roller of the present invention;

FIG. 2 shows the first layer and the second layer, and the mold set for manufacturing the support coat of the foam roller of the present invention;

FIG. 3 is a cross sectional view to show that the first layer and the second layer are put in the mold set for manufacturing the support coat of the foam roller of the present invention, and

FIG. 4 is an end view of the foam roller of the present invention.

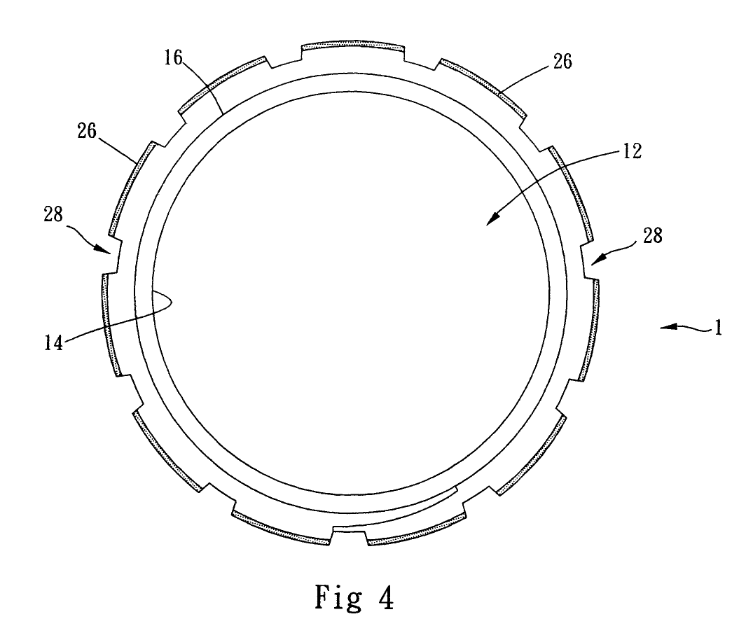

### DETAILED DESCRIPTION OF THE PREFERRED EMBODIMENT

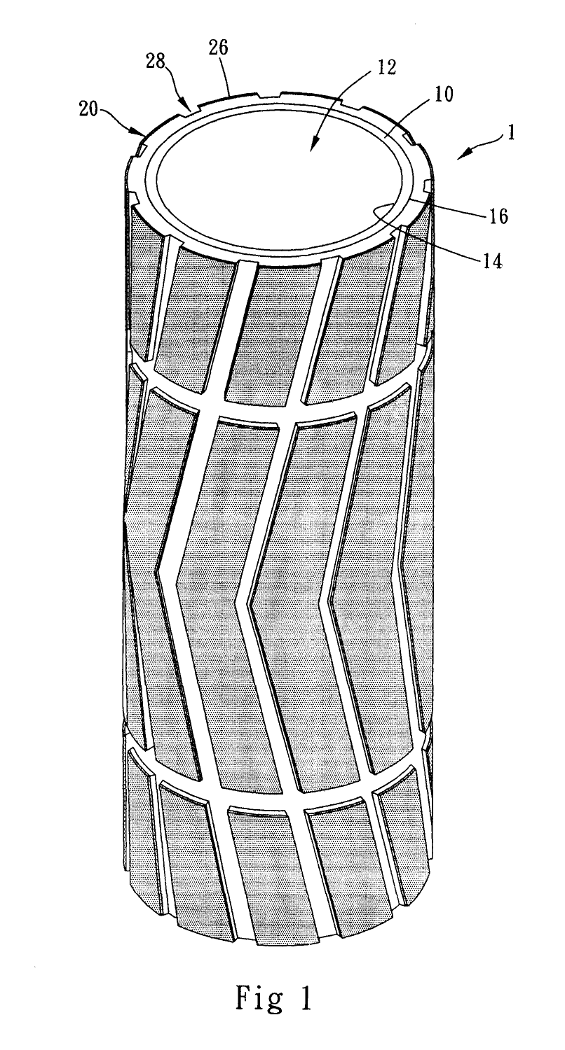

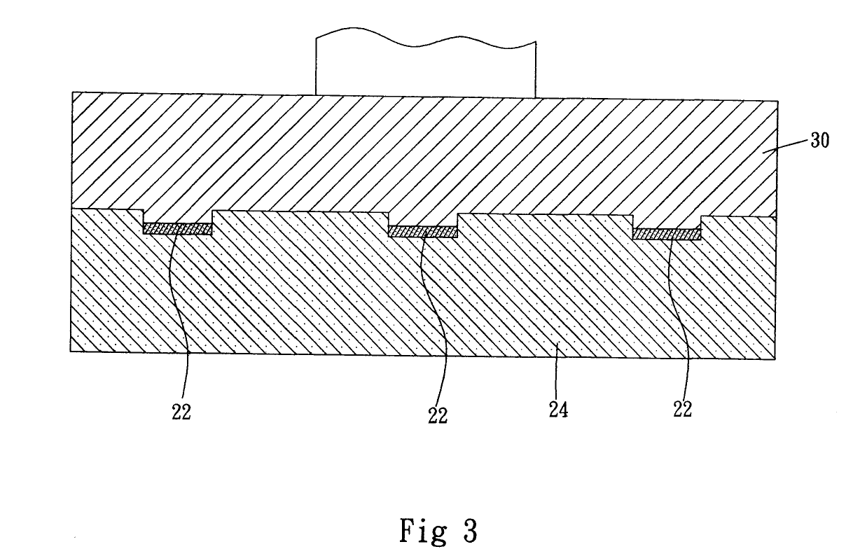

Referring to FIGS. 1 to 3, the foam roller 1 of the present invention comprises a body 10 which is a cylindrical body and has a passage 12 defined axially therethrough. The body 10 has an inner surface 14 and an outer surface 16. A support coat 20 is connected to the outer surface 16 of the body 10 and has a first layer 22 and a second layer 24. The first layer 22 has multiple slots 222 defined therethrough.

The color of the second layer 24 is different from the color of the first layer 22. Multiple protrusions 242 are formed on the outside of the second layer 24. The second layer 24 is connected to the outside of the first layer 22 by way of heat pressing to form the support coat 20. The protrusions 242 extend through the slots 222 and form multiple massage portions 26. The color of the outside of each massage portion 26 is different from the color of the first layer 22.

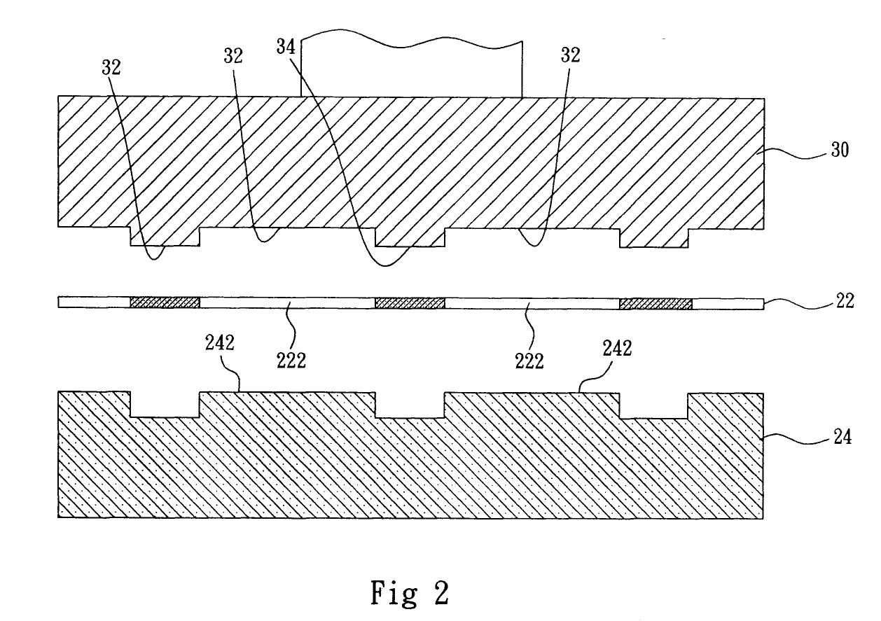

As shown in FIG. 2, after the first layer 22 has the slots 222 defined therethrough, the first layer 22 with the slots 222 is put in a mold set 30. The ridges 34 of the mold set 30 are located corresponding to the area that does not have the slots 222. The second layer 24 is then overlapped on the first layer 22. The mold set 30 is operated to connect the second layer 24 to the first layer 22 by way of the heat pressing. During the process of the heat pressing, the protrusions 242 formed on the second layer 24 extend through the slots 222 of the first layer 22 to form the multiple massage portions 26. The color of the outside of each massage portion 26 is different from the color of the first layer 22. Multiple grooves 28 are defined in the area of the first layer 22 that is located corresponding to the ridges 34 of the mold set 30. A connection wall 29 is formed and connected between each of the grooves 28 and the massage portion 26 corresponding to the groove 28. The color of the connection wall 29 is the same as the color of the first layer 22, and different from the color of the second layer 24.

The first layer 22 with the slots 222 is put in the mold set 30, wherein the slots 222 can be shaped to represent patterns, geometric slots, or characters. The color of the massage portions 26 is different from the color of the grooves 28 so that the foam roller has two different colors which provide better visual effect.

While we have shown and described the embodiment in accordance with the present invention, it should be clear to those skilled in the art that further embodiments may be made without departing from the scope of the present invention.

What is claimed is:

1. A foam roller comprising:
a body having a passage defined axially therethrough, the body having an inner surface and an outer surface, and
a support coat connected to the outer surface of the body and having a first layer and a second layer, the first layer having multiple slots defined therethrough, the second layer having a color which is different from a color of the first layer, multiple protrusions formed on an outside of the second layer, the second layer connected to an outside of the first layer by way of heat pressing to form the support coat, the protrusions extending through the slots and forming multiple massage portions, a color of an outside of each massage portion being different from the color of the first layer.

2. The foam roller as claimed in claim 1, wherein multiple grooves are defined in an area of the first layer that that does not have the slots, a connection wall is formed and connected between each of the grooves and the massage portion corresponding to the groove, a color of the connection wall is the same as the color of the first layer and different from the color of the second layer.

3. The foam roller as claimed in claim 2 further comprising a mold set, the first layer with the slots being put in the mold set and the second layer being overlapped on the first layer, the second layer being connected to the first layer by way of the heat pressing, during heat pressing, the protrusions on the second layer extending through the slots of the first layer, the grooves being defined in the area of the first layer that does not have the slots.
